(19) United States
(12) Patent Application Publication
(10) Pub. No.: US 2026/0194138 A1
(43) Pub. Date: Jul. 9, 2026

(54) METHOD FOR OPERATING A MULTIPLE CLUTCH TRANSMISSION AND CORRESPONDING MULTIPLE CLUTCH TRANSMISSION

(71) Applicant: AUDI Aktiengesellschaft, Ingolstadt (DE)

(72) Inventors: Walter PROCHAZKA, Hepberg (DE); Dominik DOBLINGER, Ingolstadt (DE)

(73) Assignee: AUDI Aktiengesellschaft, Ingolstadt (DE)

(21) Appl. No.: 19/129,720

(22) PCT Filed: Nov. 7, 2023
(86) PCT No.: PCT/EP2023/081024

§ 371 Date: May 14, 2025

(30) Foreign Application Priority Data
Nov. 14, 2022 (DE) 102022212039.6

(51) Int. Cl. F16H 61/688; F16H 61/04

(52) U.S. Cl. CPC F16H 61/688; F16H 2061/0433

(57) ABSTRACT

A method for operating a multiple clutch transmission for a motor vehicle. The multiple clutch transmission includes a transmission input shaft coupled or couplable to a drive device of the motor vehicle and a transmission output shaft, which are drive-coupled to one another at least temporarily via a first clutch and a first sub-transmission and at least temporarily via a second clutch and a second sub-transmission. An electric machine is coupled to the output side of the multiple clutch transmission at least temporarily to provide a drive torque. A first target clutch torque other than zero is set at least temporarily on the first clutch and a second target clutch torque other than zero is set at the same time on the second clutch.

### FIELD

The invention relates to a method for operating a multiple clutch transmission for a motor vehicle, wherein the multiple clutch transmission has a transmission input shaft coupled or couplable to a drive device of the motor vehicle and a transmission output shaft, which are drive-coupled to one another at least temporarily via a first clutch and a first sub-transmission and at least temporarily via a second clutch and a second sub-transmission. The invention further relates to a corresponding motor vehicle.

### BACKGROUND

Publication DE 102 44 026 A1, for example, is known from the prior art. This describes a method and a device for actively reducing clutch slip in a motor vehicle. In motor vehicles, vibrations occur during the slip phase of a clutch in the drive train, which are generated in the vehicle clutch. These vibrations occur when a slipping clutch generates periodic torques that lie in the natural frequency range of the drivetrain, which is dynamically separated by the clutch. Such torsional vibrations are converted into longitudinal vibrations in the drivetrain by the vehicle's drive wheels and are perceived as detrimental by the vehicle occupants. A method and a device are presented with which these disturbing vibrations are reduced, at least in terms of their amplitude. For this purpose, a method is provided for using a control and regulation device and suitable sensors to detect the disturbing vibrations and, if previously defined limit values are exceeded, to actuate at least one device which acts on components of the vehicle in such a way that the disturbing vibrations are damped or compensated for.

### SUMMARY

The objective of the invention is to propose a method for operating a motor vehicle which comprises advantages over the prior art, in particular enables the motor vehicle to be driven as flexibly and quietly as possible by means of an electric machine.

According to the invention, this is solved with a method for operating a motor vehicle. It is provided that an electric machine is coupled at least temporarily to the output side of the multiple clutch transmission in order to provide a drive torque, wherein at least temporarily a first target clutch torque other than zero is set on the first clutch and at the same time a second target clutch torque other than zero is set on the second clutch.

It should be noted that the exemplary embodiments explained in the description are not limiting; rather, any variations of the features disclosed in the description, the claims and the figures can be realised.

The multiple clutch transmission is preferably part of the motor vehicle. The motor vehicle comprises the drive device for driving it. In this respect, the drive device serves to provide a drive torque directed towards driving the motor vehicle. The drive torque is provided at least temporarily by a drive unit of the drive device, which is preferably in the form of an internal combustion engine. The multiple clutch transmission is provided and configured to couple the drive device or the drive unit of the drive device to at least one wheel axle of the motor vehicle in terms of drive technology. At least temporarily, the wheel axle is therefore drive-technically coupled or connected to the drive device via the multiple clutch transmission.

The multiple clutch transmission comprises the transmission input shaft, via which the multiple clutch transmission is coupled to the drive device. In this respect, the drive device or the drive unit of the drive device is coupled or can be coupled to the multiple clutch transmission on the input side, in particular permanently and/or via at least one start-up clutch. On the output side, the multiple clutch transmission includes the transmission output shaft. The transmission output shaft is, for example, coupled or at least couplable to the at least one wheel axle of the motor vehicle. The wheel axle of the motor vehicle preferably comprises several sub-axes, which are connected both to each other and to the transmission output shaft via an axle differential. At least one wheel of the motor vehicle is present on each of the sub-axles, so that the wheels of the motor vehicle are drive-coupled to each other and to the transmission output shaft via the axle differential.

The multiple clutch transmission comprises the first sub-transmission and the second sub-transmission, via which the transmission input shaft is at least temporarily drive-coupled to the transmission output shaft. For example, the transmission input shaft is at least temporarily connected to the transmission output shaft in a rotationally fixed manner via the first clutch and the first sub-transmission. By opening and closing the first clutch accordingly, the rotationally fixed connection between the transmission input shaft and the first sub-transmission can be interrupted or established. The same applies to the second clutch and the second sub-transmission.

The first sub-transmission and the second sub-transmission preferably comprise different transmission ratios. This means that a transmission ratio between the transmission input shaft and the transmission output shaft can be switched or adjusted by opening and closing the two clutches accordingly. The multiple clutch transmission is therefore a dual clutch transmission. Preferably, the first sub-transmission and the second sub-transmission are each configured as a manual transmission with multiple gears, on which at least one gear can be selected and set from the multiple gears. The gears of the two sub-transmissions differ from each other in terms of their transmission ratio. In this respect, the multiple clutch transmission has several gears, which are made up of the gears of the first sub-transmission and the gears of the second sub-transmission and each comprise different transmission ratios. On the output side, the two sub-transmissions are connected to the transmission output shaft in a rotationally fixed manner, in particular permanently.

The invention provides for an electric machine to be present in addition to the drive device of the motor vehicle. Said machine is provided and configured to provide, at least temporarily, the drive torque directed towards driving the motor vehicle, in particular without support from the drive device. The drive torque is thus provided at times by the drive device, at times by the electric machine and at times by the drive device and the electric machine together. In particular, the motor vehicle is a hybrid motor vehicle.

To provide the drive torque, the electric machine is coupled, at least temporarily, to the output side of the multiple clutch transmission. This means that the electric machine is coupled to the multiple clutch transmission in such a way that a drive torque can be provided or is provided at the transmission output shaft by means of the electric machine even when the first clutch is fully open and the second clutch is fully open. For this purpose, the electric machine can preferably be rigidly coupled or at least temporarily rigidly coupled to the transmission output shaft even when the first clutch is fully open and the second clutch is fully open.

It is particularly preferable that the electric machine can be coupled to the transmission output shaft, in particular by means of a disconnect clutch. This means that the electric machine is connected to the transmission output shaft via the disconnect clutch, in particular directly. When the disconnect clutch is closed, the electric machine is therefore coupled to the transmission output shaft, preferably rigidly, whereas when the disconnect clutch is open, it is de-coupled from it, preferably completely. The drive device is thus coupled or couplable on the input side to the transmission input shaft of the multiple clutch transmission, while the electric machine is coupled or couplable on the output side to the transmission output shaft of the multiple clutch transmission. In other words, the drive device is only indirectly connected to the transmission output shaft via the multiple clutch transmission. The electric machine, on the other hand, is directly coupled to the transmission output shaft or can at least be coupled to it.

In principle, the electric machine can be provided at any point between the multiple clutch transmission and the least one wheel axle of the motor vehicle. For example, the electric machine can be integrated into the wheel axle of the motor vehicle and/or into a wheel hub of the wheel axle. However, it is particularly preferable for the electric machine to be part of the multiple clutch transmission. For example, the electric machine is integrated into a housing of the multiple clutch transmission on a side opposite the transmission input shaft and/or is attached to the housing.

It is now provided that, at least temporarily, only the electric machine is used to drive the motor vehicle. Such a condition exists, for example, when the motor vehicle configured as a hybrid motor vehicle is in a purely electric driving mode. In this case, the electric machine coupled to the multiple clutch transmission on the output side is operated to provide the drive torque. Preferably, the drive unit is at a standstill, switched off or idling. A standstill of the drive unit means in particular that a drive shaft of the drive unit, for example a crankshaft of the drive unit configured as an internal combustion engine, comprises a rotational speed of zero. However, it may also be provided that the drive unit is idling, for example, wherein the drive shaft comprises a rotational speed other than zero, but does not contribute to the drive torque.

During such operation, it could now be provided to fully open both the first clutch and the second clutch, whereby the transmission input shaft and the transmission output shaft would be completely separated from each other in terms of drive technology and consequently the drive device would also be completely separated from the two sub-transmissions. However, during operation of the electric machine coupled to the multiple clutch transmission on the output side, the rotational speed of the transmission output shaft is at least temporarily different from zero.

Due to the complete separation of the two sub-transmissions from the transmission input shaft on the input side and their rotationally fixed coupling with the transmission output shaft on the output side, acoustic noises can occur at non-zero rotational speed of the transmission output shaft due to mechanical play in the two sub-transmissions caused by the manufacturing process, which are perceived as disturbing by a driver of the motor vehicle. In particular, side play occurring between the gearwheels of the two sub-transmissions during load changes of the electric machine leads to acoustic noises that can be perceived as disturbing.

The invention now provides for setting the first target clutch torque at least temporarily on the first clutch and, at the same time, the second target clutch torque on the second clutch. The first target clutch torque and the second target clutch torque are other than zero, in particular greater than zero. This means that the first clutch and the second clutch are set to transmit at most the torque corresponding to the first target clutch torque and the second target clutch torque respectively. The target clutch torque is therefore a torque that can be transmitted as a maximum via the respective clutch.

The first clutch and the second clutch are configured, for example, as a hydraulically or mechanically actuated clutch, in particular as a multi-plate clutch. Accordingly, the two clutches each comprise an actuating element by means of which a pressing force is applied to the clutch. The pressing force is determined on the basis of the target clutch torque and this pressing force is set on the respective clutch. Consequently, a slip occurs on the two clutches if the drive torque provided by the output side, in particular the drive torque provided by the electric machine, is greater than the target clutch torque set on the respective clutch.

In other words, the invention provides that, at least temporarily, at a rotational speed of the transmission output shaft other than zero, a target clutch torque other than zero is set at the first clutch and at the second clutch, namely the first target clutch torque and the second target clutch torque. In this case, it may be provided that the first target clutch torque corresponds to the second target clutch torque, for example if the first clutch and the second clutch are configured identically. In this respect, a target clutch torque other than zero is set at least temporarily on the first clutch and at the same time on the second clutch. This means that the two clutches are not fully open, but are at least partially slip-closed. This is preferably done during purely electric operation of the motor vehicle.

The procedure described above results in both the first sub-transmission and the second sub-transmission being at least slip-connected to the transmission input shaft via the respective clutch during purely electric driving operation. By setting the non-zero first target clutch torque and the non-zero second target clutch torque on the two clutches, the two sub-transmissions are mechanically tensioned, which reduces or avoids the acoustic noises described above. The invention thus enables particularly low-noise driving operation using the electric machine coupled to the multiple clutch transmission on the output side.

An embodiment of the invention provides that the first target clutch torque and/or the second target clutch torque are each selected to be greater than a slip point torque corresponding to a slip point of the respective clutch. The slip point or also kiss point or gripping point of the shift clutch is to be understood in particular as a pressing force, the presence of which at the respective clutch results in at least a minimum frictional connection between the transmission input shaft and the respective sub-transmission, so that at least the slip point torque can be transmitted via the respective clutch. For example, there is a contact between the friction surfaces of the clutches configured as multi-plate clutches, so that at least the slip point torque can be transmitted via the multi-plate clutch with the greatest possible slip. The first target clutch torque and/or the second target clutch torque are now selected to be greater than the slip point torque. This ensures that at least the slip point torque can be reliably transmitted via the respective clutch.

As the slip point or the slip point torque on the respective clutch cannot usually be determined exactly, it can alternatively be provided that the slip point torque for each of the clutches is determined from a corresponding characteristic curve and/or determined as part of a series of tests. In this case, the respective target clutch torque is selected as being equal to the determined and/or ascertained slip point torque. In practice, depending on a clutch design and a component tolerance, a slip point torque of approximately 2 Nm to 8 Nm, for example, has proven itself. If this value is selected as the target clutch torque, the procedure according to the invention can be carried out reliably with the lowest possible friction losses.

An embodiment of the invention provides that the first target clutch torque and/or the second target clutch torque are each selected to be less than a nominal clutch torque of the respective clutch. The nominal clutch torque is to be understood as the greatest possible torque that can be transmitted reliably and without slippage via the respective clutch during intended operation without causing permanent damage to the clutch.

Preferably, the first target clutch torque and/or the second target clutch torque correspond to at most 5%, at most 4%, at most 3%, at most 2% or at most 1% of the nominal clutch torque. In this way, the first target clutch torque and/or the second target clutch torque are selected in a particularly simple manner on the basis of a known nominal clutch torque of the respective clutch.

An embodiment of the invention provides that the first target clutch torque and the second target clutch torque are set on the clutches during a load change. A load change is to be understood in particular as an acceleration or a deceleration of the motor vehicle, in particular a starting process of the motor vehicle from a standstill. During such a load change, a corresponding acceleration or deceleration of the rotational speed of the transmission output shaft occurs, which leads to undesirable acoustic noise due to the mechanical play of the two sub-transmissions explained above.

It is now provided to set the first target clutch torque and the second target clutch torque on the clutches. This is done, for example, using a speed gradient of the transmission output shaft. This reduces or avoids the undesirable acoustic noises caused by the load change.

An embodiment of the invention provides that before the load change is carried out and/or after the load change has been carried out, a third target clutch torque is set on the clutches at least temporarily, which is equal to zero. In this respect, the third target clutch torque is provided in addition to the first target clutch torque and the second target clutch torque. This is set on the clutches in particular by opening them completely.

In this respect, the two clutches are initially fully open, at least temporarily, before the load change is carried out. When the load change is carried out, in particular immediately at the start of the load change, the first target clutch torque and the second target clutch torque are set on the clutches. This is done, for example, by means of a control device that recognises an imminent load change, for example by means of an actuation of an accelerator pedal and/or a brake pedal by a driver of the motor vehicle. Additionally and/or alternatively, the imminent load change can be recognised by a driver assistance system.

After the load change has been carried out, in particular immediately after the end of the load change, the third target clutch torque is set again, at least temporarily, on the clutches. This is preferably also carried out by means of the control device, which is provided and configured accordingly to recognise the end of the load change. This procedure minimises the friction losses occurring at the clutches.

An embodiment of the invention provides that the load change is a load change of the electric machine. In particular, the load change is a load change of the electric machine during purely electric operation of the motor vehicle. The electric machine is preferably controlled by means of power electronics. A load change of the electric machine is therefore associated with a corresponding control of the power electronics.

It is now provided to set the first target clutch torque and the second target clutch torque on the clutches during a load change of the electric machine.

This avoids the aforementioned acoustic noises that occur due to a change in the speed of the transmission output shaft caused by the load change of the electric machine. This enables particularly quiet, purely electric operation of the motor vehicle.

An embodiment of the invention provides that the electric machine is coupled to the transmission output shaft via a spur gear and/or by means of a disconnect clutch. As already explained above, the electric machine is coupled to the multiple clutch transmission on the output side. The spur gear comprises at least one spur gear stage and enables a particularly space-saving arrangement of the electric machine on the multiple clutch transmission. Here, for example, an axis of rotation of the electric machine, in particular an axis of rotation of a stator of the electric machine, is arranged parallel to an axis of rotation of the transmission output shaft.

Additionally and/or alternatively, the disconnect clutch is present. The disconnect clutch is preferably configured as a claw clutch and enables the electric machine to be disconnected from the multiple clutch transmission. The disconnect clutch is preferably arranged coaxially to the transmission output shaft. The electric machine or the axis of rotation of the stator of the electric machine is, for example, also arranged coaxially or alternatively parallel to the axis of the transmission output shaft by means of the spur gear. This enables a compact and space-saving arrangement of the electric machine. At the same time, the motor vehicle can be driven without using the electric machine.

An embodiment of the invention provides that the transmission output shaft and/or the electric machine are coupled, at least temporarily, to a first wheel axle and/or a second wheel axle of the motor vehicle. Reference has already been made above to the at least one wheel axle of the motor vehicle. The at least one wheel axle is preferably the first wheel axle. This is preferably permanently coupled to the transmission output shaft and is present, for example, as a front axle of the motor vehicle. In addition to the first wheel axle, the second wheel axle is present, for example as a rear axle of the motor vehicle. In principle, however, the first wheel axle can also be present as the rear axle and the second wheel axle as the front axle of the motor vehicle.

In this respect, the motor vehicle comprises at least two wheel axles, wherein the first wheel axle is permanently coupled to the transmission output shaft. The second wheel axle can also be permanently coupled to the transmission output shaft. Preferably, however, the second wheel axle is coupled to the transmission output shaft by means of a third clutch. The second wheel axle can be disconnected from the transmission output shaft by means of the third clutch. The third clutch is preferably part of the multiple clutch transmission and is configured as a multi-plate clutch.

Preferably, the third clutch is integrated into the multiple clutch transmission between the two sub-transmissions and the electric machine coupled to the multiple clutch transmission on the output side. This allows both the second wheel axle and the electric machine to be separated from the transmission output shaft in terms of the drive by means of the third clutch. This creates a particularly flexible multiple clutch transmission.

An embodiment of the invention provides that the first target clutch torque and the second target clutch torque are set at the clutches when a rotational speed of the transmission output shaft is within a rotational speed range delimited by a first rotational speed limit and a second rotational speed limit. Due to further acoustic noise sources, such as wind noise and rolling noises of the motor vehicle's wheels, the volume of which depends on the instantaneous travelling speed of the motor vehicle, the acoustic noises described above, which are caused by the mechanical play of the sub-transmission, are only perceived as disturbing if they are within the speed range.

The first speed limit value preferably corresponds to a minimum travelling speed of the motor vehicle, which the vehicle must have reached before the method according to the invention is applied. Particularly preferably, the first speed limit value corresponds to a driving speed of zero, so that the method according to the invention is already carried out during a start-up process by means of the electric machine. During such a start-up process, the acoustic noises are perceived as particularly disturbing.

The second speed limit value preferably corresponds to a maximum speed of the motor vehicle, after exceeding which the method according to the invention is no longer carried out. Preferably, the maximum speed corresponds to a travelling speed at which the drive torque provided to drive the motor vehicle is no longer provided by the electric machine or is only provided jointly by the electric machine and the drive device. This ensures that the method is only carried out within a travelling speed range in which purely electric driving of the motor vehicle with the electric machine is provided.

The invention also relates to a multiple clutch transmission for a motor vehicle, in particular for carrying out the method as described herein, wherein the multiple clutch transmission includes a transmission input shaft coupled or couplable to a drive device of the motor vehicle and a transmission output shaft which are at least temporarily coupled to one another on the drive side via a first clutch and a first sub-transmission and at least temporarily via a second clutch and a second sub-transmission. It is provided that an electric machine is coupled at least temporarily to the output side of the multiple clutch transmission to provide a drive torque, wherein the multiple clutch transmission is provided and configured to set, at least temporarily, a first target clutch torque other than zero at the first clutch and, at the same time, a second target clutch torque other than zero at the second clutch.

The invention further relates to a motor vehicle with a multiple clutch transmission, in particular a multiple clutch transmission according to the embodiments within the scope of this description.

The advantages of such a configuration of the multiple clutch transmission and the motor vehicle as well as a corresponding procedure have already been pointed out. Both the multiple clutch transmission and the motor vehicle as well as the method for operating them can be further developed in accordance with the explanations in the context of this description, so that reference is made to them in this respect.

The features and combinations of features described in the description, in particular the features and combinations of features described in the following description of the figures and/or shown in the figures, can be used not only in the combination indicated in each case, but also in other combinations or on their own, without departing from the scope of the invention. Thus, embodiments which are not explicitly shown or explained in the description and/or the figures, but which emerge from the explained embodiments or can be derived therefrom by combinations of features, are also to be regarded as being comprised by the invention.

### BRIEF DESCRIPTION OF THE FIGURES

The invention is explained in more detail below with reference to the exemplary embodiments shown in the drawing, without limiting the invention. The only example shown in

FIG. 1 is a schematic representation of a motor vehicle with a drive device.

### DETAILED DESCRIPTION

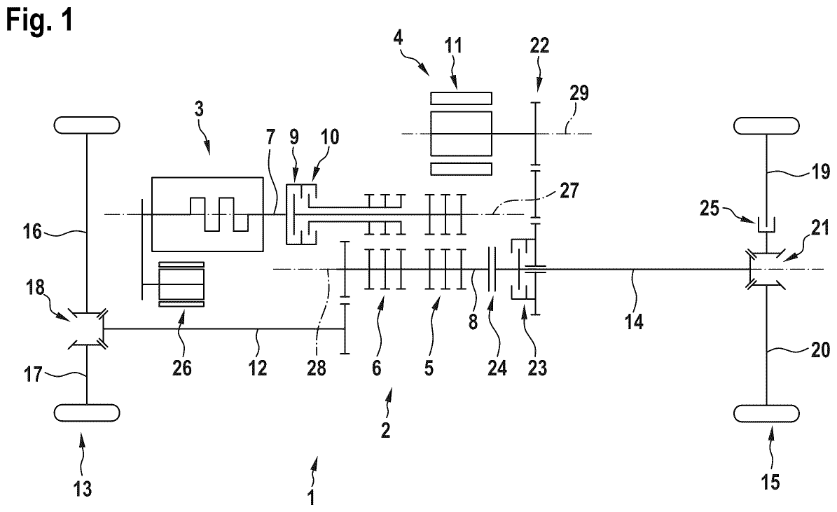

FIG. 1 shows a schematic representation of a motor vehicle 1 with a drive device 2. The drive device 2 comprises a drive unit 3 and a multiple clutch transmission 4. The multiple clutch transmission 4 comprises a first sub-transmission 5 and a second sub-transmission 6. A transmission input shaft 7 and a transmission output shaft 8 are coupled to each other at least temporarily via a first clutch 9 and the first sub-transmission 5 and at least temporarily via a second clutch 10 and the second sub-transmission 6. The two sub-transmissions 5 and 6 are coupled to the transmission output shaft 8 in a rotationally fixed manner. In this respect, the multiple clutch transmission 4 is a dual clutch transmission.

An electric machine 11 is drive-coupled to the transmission output shaft 8 on the output side. The transmission output shaft 8 is connected to a first wheel axle 13 via a first output shaft 12 and to a second wheel axle 15 of the motor vehicle 1 via a second output shaft 14. The first wheel axle 13 comprises a first sub axle 16 and a second sub axle 17, which are drive-coupled to one another and to the first output shaft 12 via a first axle differential 18. Accordingly, the second wheel axle 15 comprises a first sub-axle 19, a second sub-axle 20 and a second axle differential 21.

The electric machine 11 is coupled to a disconnect clutch 23 via a spur gear 22. The disconnect clutch 23 is arranged coaxially to an axis of rotation of the transmission output shaft 8. The disconnect clutch 23 serves to disconnect the electric machine 11 from the transmission output shaft 8 and is configured, for example, as a claw clutch. The second output shaft 14 is drive-coupled to the transmission output shaft 8 via a third clutch 24. The third clutch 24 is configured, for example, as a multi-plate clutch and serves to disconnect the second output shaft 14 from the transmission output shaft 8. A further disconnect clutch 25 is arranged between the second output shaft 14 and the second axle differential 21 in terms of the drive, which is configured, for example, as a claw clutch. By opening the third clutch 24 and the further disconnect clutch 25, the second wheel axle 15, the second output shaft 14 and the transmission output shaft 8 can be completely separated from each other in terms of drive. A further electric machine 26 is arranged on the drive unit 3, which serves to start the drive unit 3.

The transmission input shaft 7 and a crankshaft of the drive unit 3 comprise a common axis of rotation 27. In this respect, the axes of rotation of the transmission input shaft 27 and the crankshaft are arranged coaxially to one another. The transmission output shaft 8 and the second output shaft 14 comprise a common axis of rotation 28. In this respect, the axes of rotation of the transmission output shaft 8 and the second output shaft 14 are arranged coaxially to each other and offset parallel to the axis of rotation 27 of the transmission input shaft 7 and the crankshaft. An axis of rotation 29 of the electric machine 11 is arranged offset parallel to the axes of rotation 27 and 28.

The electric machine 11 is operated at least temporarily to drive the motor vehicle 1 when the drive unit 3 is switched off. In this case, a target clutch torque other than zero is set at least temporarily at the first clutch 9 and at the same time at the second clutch 10. As a result, the two sub-transmissions 5 and 6 are mechanically pre-tensioned during purely electric driving operation of the motor vehicle 1, so that acoustically perceptible noises, which are caused in particular by backlash between the teeth of the two sub-transmissions 5 and 6, are reduced.

### LIST OF REFERENCE SIGNS

1 Motor vehicle
2 Drive device
3 Drive unit
4 Multiple clutch transmission
5 First sub-transmission
6 Second sub-transmission
7 Transmission input shaft
8 Transmission output shaft
9 First clutch
10 Second clutch
11 Electric machine
12 First output shaft
13 First wheel axle
14 Second output shaft
15 Second wheel axle
16 First sub axle
17 Second sub axle
18 First axle differential
19 First sub axle
20 Second sub axle
21 Second axle differential
22 Spur gear
23 Disconnect clutch
24 Third clutch
25 Further disconnect clutch
26 Further electric machine
27 Axis of rotation
28 Axis of rotation
29 Axis of rotation

1-10. (canceled)

11. A method for operating a multiple clutch transmission for a motor vehicle, wherein the multiple clutch transmission includes a transmission input shaft coupled or couplable to a drive device of the motor vehicle and a transmission output shaft which are at least temporarily drive-coupled to one another via a first clutch and a first sub-transmission and at least temporarily via a second clutch and a second sub-transmission, wherein an electric machine is coupled at least temporarily to the output side of the multiple clutch transmission in order to provide a drive torque, wherein at least temporarily a first target clutch torque other than zero is set on the first clutch and a second target clutch torque other than zero is set at the same time on the second clutch.

12. The method according to claim 11, wherein the first target clutch torque and/or the second target clutch torque are each selected to be greater than a slip point torque corresponding to a slip point of the respective clutch.

13. The method according to claim 11, wherein the first target clutch torque and/or the second target clutch torque are each selected to be less than a nominal clutch torque of the respective clutch.

14. The method according to claim 11, wherein the first target clutch torque and the second target clutch torque are set during a load change on the clutches.

15. The method according to claim 11, wherein before the load change is carried out and/or after the load change has been carried out on the clutches, a third target clutch torque, which is equal to zero, is set at least temporarily in each case.

16. The method according to claim 11, wherein the load change is a load change of the electric machine.

17. The method according to claim 11, wherein the electric machine is coupled to the transmission output shaft via a spur gear and/or by means of a disconnect clutch.

18. The method according to claim 11, wherein the transmission output shaft and/or the electric machine are coupled at least temporarily to a first wheel axle and/or a second wheel axle of the motor vehicle.

19. The method according to claim 11, wherein the first target clutch torque and the second target clutch torque are set at the clutches when a rotational speed of the transmission output shaft is within a rotational speed range delimited by a first rotational speed limit value and a second rotational speed limit value.

20. A multiple clutch transmission for a motor vehicle, wherein the multiple clutch transmission includes a transmission input shaft coupled or couplable to a drive device of the motor vehicle and a transmission output shaft, which are drive-coupled to one another at least temporarily via a first clutch and a first sub-transmission and at least temporarily via a second clutch and a second sub-transmission, wherein an electric machine is coupled at least temporarily to the output side of the multiple clutch transmission in order to provide a drive torque, wherein the multiple clutch transmission is provided and configured to set, at least temporarily, a first target clutch torque other than zero at the first clutch and at the same time a second target clutch torque other than zero at the second clutch.

21. The method according to claim 12, wherein the first target clutch torque and/or the second target clutch torque are each selected to be less than a nominal clutch torque of the respective clutch.

22. The method according to claim 12, wherein the first target clutch torque and the second target clutch torque are set during a load change on the clutches.

23. The method according to claim 13, wherein the first target clutch torque and the second target clutch torque are set during a load change on the clutches.

24. The method according to claim 12, wherein before the load change is carried out and/or after the load change has been carried out on the clutches, a third target clutch torque, which is equal to zero, is set at least temporarily in each case.

25. The method according to claim 13, wherein before the load change is carried out and/or after the load change has been carried out on the clutches, a third target clutch torque, which is equal to zero, is set at least temporarily in each case.

26. The method according to claim 14, wherein before the load change is carried out and/or after the load change has been carried out on the clutches, a third target clutch torque, which is equal to zero, is set at least temporarily in each case.

27. The method according to claim 12, wherein the load change is a load change of the electric machine.

28. The method according to claim 13, wherein the load change is a load change of the electric machine.

29. The method according to claim 14, wherein the load change is a load change of the electric machine.

30. The method according to claim 15, wherein the load change is a load change of the electric machine.
